(19) United States
(12) Patent Application Publication
(10) Pub. No.: US 2015/0376761 A1
(43) Pub. Date: Dec. 31, 2015

(54) SYSTEMS AND METHODS FOR PLASMA SPRAY COATING

(71) Applicant: United Technologies Corporation, Farmington, CT (US)

(72) Inventors: Henry H. THAYER, Wethersfield, CT (US); John P. RIZZO, Vernon, CT (US)

(21) Appl. No.: 14/752,172

(22) Filed: Jun. 26, 2015

Related U.S. Application Data
(60) Provisional application No. 62/019,012, filed on Jun. 30, 2014.

(51) Int. Cl. C23C 4/12; H05H 1/42; C23C 4/10

(52) U.S. Cl. CPC C23C 4/127; C23C 4/10; H05H 1/42

(57) ABSTRACT

The present disclosure relates to a method for plasma spraying. In one embodiment, a method includes controlling application of a filament embedded with powder particles to a plasma jet to generate a spray for coating a substrate. The method for plasma spraying can include controlling a plasma source to generate a plasma jet, such that the spray is formed by powder that is plasticized and output by the plasma jet to the substrate.

### CROSS-REFERENCE TO RELATED APPLICATIONS

This application claims priority to U.S. Provisional Application No. 62/019,012 filed Jun. 30, 2014 and titled SYSTEMS AND METHOD FOR PLASMA SPRAY COATING, the disclosure of which is incorporated herein by reference in its entirety.

### FIELD

The present disclosure relates to systems and methods for applying coatings, and more particularly, to systems and methods for filament plasma spray coating.

### BACKGROUND

Plasma spraying of fine powders can be very challenging in terms of the size of coating material that may be employed and the carrying medium utilized. For example, gas fed particles and liquid suspensions may result in clumping and/or uneven application of the powder. Further, a liquid suspension such as a water suspension can cool a plasma jet while a flammable liquid can create handling issues. Thus, there is a need in the art for improved plasma spraying systems and methods which utilize powders.

### BRIEF SUMMARY OF THE EMBODIMENTS

Disclosed and claimed herein are systems and methods for plasma spraying. One embodiment is directed to a method for plasma spraying. The method includes controlling application of a filament embedded with powder particles to a plasma jet to generate a spray for coating a substrate.

In one embodiment, the plasma jet is configured to burn away filament material such that the spray includes a plasticized ceramic coating.

In one embodiment, the filament includes an organic material and the powder particles include ceramic powder particles, wherein the ceramic powder particles are embedded in the organic material.

In one embodiment, the filament is an elongated material formed with a diameter in the range of 0.1 mm to 1 mm.

In one embodiment, powder particles embedded within the filament have a diameter in the range of 1 nm to 0.001 cm.

In one embodiment, the filament includes ceramic particles.

In one embodiment, controlling application of filament includes applying the filament to the plasma jet at a controlled rate.

In one embodiment, the filament is fed axially or radially into the plasma jet.

In one embodiment, the method for plasma spraying further includes controlling a plasma source to generate a plasma jet.

In one embodiment, the embedded powder particles are plasticized by the plasma jet to form a coating for the substrate.

In one embodiment, the method for plasma spraying further includes controlling the position of at least one of a substrate and plasma device during coating or spraying.

One embodiment is directed to a plasma spraying system including a plasma source, a filament feed element configured to store and output a filament, and a control coupled to the plasma source and filament feed element. The control is configured to control a plasma source to generate a plasma jet, and control application of a filament to the plasma jet to generate a spray for coating a substrate.

One embodiment is directed to a filament including embedded ceramic particles, wherein the filament is configured to for application to a plasma source.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts an exemplary process for plasma spraying according to one or more embodiments;

FIG. 2 depicts a graphical representation of a plasma spraying system according to one or more embodiments;

FIG. 3 depicts a graphical representation of an axial feed plasma spraying system according to one or more embodiments; and

FIG. 4 depicts a graphical representation of an axial feed plasma spraying system according to one or more embodiments.

### DETAILED DESCRIPTION OF THE EXEMPLARY EMBODIMENTS

### Overview and Terminology

One aspect of this disclosure relates to plasma spraying components. In one embodiment, a method for plasma spraying includes application of a filament embedded with one or more powders, such as a fine ceramic powder, to a plasma jet to generate plasticized ceramic particles which impact a substrate, freeze, and form a ceramic coating. In another embodiment, a system is provided including a feed element for the filament and at least a controller to control application of the filament to a plasma jet.

In one embodiment, fine, or very fine (e.g., nano fine) ceramic powder is embedded in an organic filament during a filament extrusion process. The filament is then fed into a plasma jet at a controlled rate, similar to a wire spray process. Once exposed to the plasma jet, the organic filament burns away and the ceramic powder is plasticized and accelerated by the plasma jet, and flies through the air to the substrate where it deposits as a ceramic coating.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

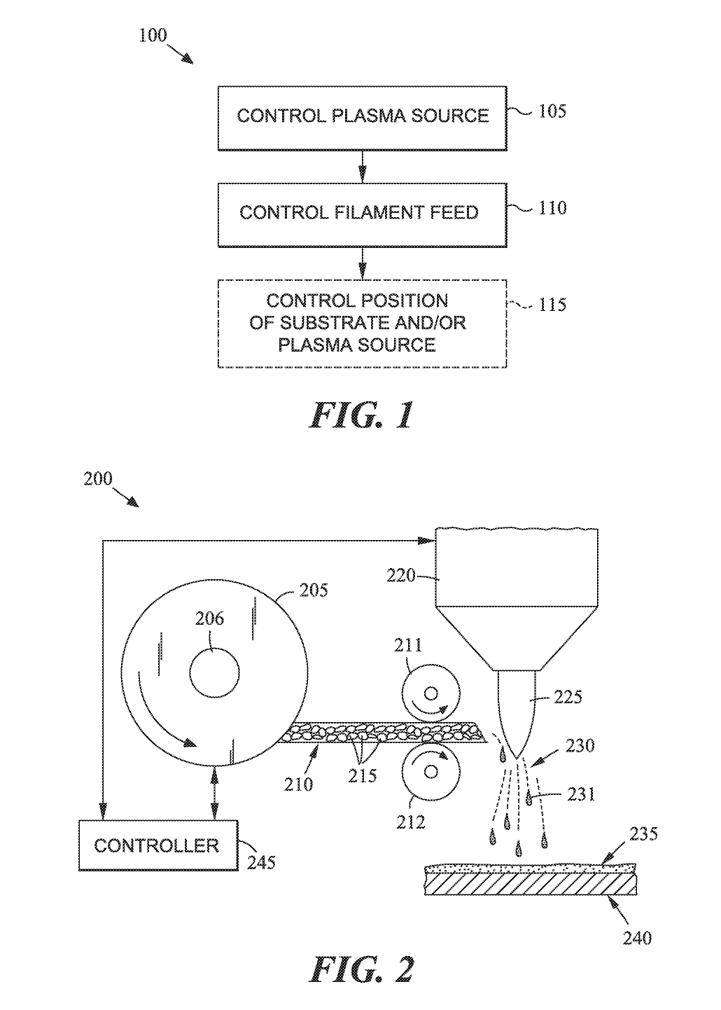

Referring now to the figures, FIG. 1 depicts process 100 for plasma spraying according to one or more embodiments. Process 100 may be initiated at block 105 with controlling a plasma source, such as the plasma source of FIGS. 2-4, to generate a plasma jet configured to burn away filament material and generate a plasticized spray for coating a substrate with the plasticized ceramic of the spray.

At block 110, process 100 controls feed of a filament embedded with powder to a plasma jet at a controlled rate to generate a plasma spray for coating a substrate. As further discussed below, the filament may be fed axially or radially into the plasma jet. The plasma spray generated by the plasma jet and filament forms a wear or heat resistant coating on the substrate. The rate of feed of the filament to a plasma device can vary in accordance with the type of device utilized. The feed rate may depend on, for example, the amount of oxygen and fuel fed into a High Velocity Oxy-Fuel device. Similarly, the filament feed rate can be adjusted based on the power level in the plasma gun.

Process 100 may optionally include controlling the position of the substrate and/or plasma source in some embodiments. At block 115, positioning of the substrate and/or the plasma source may also be controlled.

FIG. 2 depicts a graphical representation of a plasma spraying system according to one or more embodiments. System 200 includes a feed device 205, a plasma device 220, and a controller 245 configured to control or operate the feed device 205 to output a filament 210 to a plasma device 220. The plasma device 220 produces a plasma jet 225 which receives the filament 210 and generates coating spray 230. The coating spray 230 can include one or more plasticized ceramic particles or powder, and forms a coating 235 on substrate 240.

Feed device 205 is configured to store and output filament 210. In certain embodiments, feed device 205 includes a rotational spool 206 controlled by controller 245 to output filament 210 at a controlled rate. In certain embodiments, feed wheels 211 and 212 are configured to guide and/or draw filament from feed device 205.

According to one embodiment, filament 210 is an organic binder material including ceramic powder particles embedded in the organic material. Filament 210 may be formed as an elongated material (e.g., string, rod, tube, etc.) with a diameter in the range of 0.1 mm to 1 mm. Similarly, powder particles 215 embedded within the filament 210, which may be ceramic particles, can have a diameter in the range of 1 nm to 0.001 cm. As filament 210 is applied to the plasma jet 225 at a controlled rate, the plasma jet 225 burns the organic filament away, plasticizes the ceramic powder embedded in the filament, and accelerates the plasticized ceramic to substrate 240 where it deposits as a ceramic coating 235. Filament 210 may be embedded with a fine powder and into an organic filament, like nylon, polyester, polyurethane, etc.

Filament 210 may be very thin, on the order of 1 mm or less and may use a fairly high concentration of ceramic, such as Aluminum Oxide (Alumina) or Yttrium Oxide (Yttiria). The bend radius of filament 210 may depend on the filament diameter and ceramic concentration. Bend radius can affect how filaments are stored. In accordance with the present disclosure, fine, or nano fine, ceramic powder is embedded in an organic filament, such as 210. In one embodiment, the powder particles 215 may be embedded by feeding the powder into the molten plastic during an extrusion process.

In certain embodiments, filament 210 may be formed with one or more shapes (e.g., with its cross-section or outer surface having a particular shape) to allow for one or more shapes or pellets to be generated by system 200. Utilizing a filament 210 with a particular cross-sectional or shape in system 200 allows for different coverage for the coating 235 to the substrate 240 during plasma spraying due to differences in plasticizing due to the particular shapes. Similarly, applying a particular cross-sectional shape to filament 210 provides different coverage during plasma spraying due to differences in velocity of the plasticized ceramic due to shape. Exemplary cross-sectional shapes of filament 210 include, but are not limited to, circular, square, rectangular, triangular, star, oval, etc.

Controller 205 may be configured to control the position of at least one of the substrate 240 and plasma source 220 during coating or spraying. Plasma source 220 may be configured to output plasma jet 225 based on one or more control signals received from controller 245. Plasma source 220 may be an electric-arc source, high velocity oxy-fuel (HVOF) source, and/or thermal source in general.

Coating spray 230 includes plasticized ceramic 231. The melted ceramic 231 is formed from the particles 215 of filament 210. The ceramic may be one of aluminum oxide or other ceramic powders, including, but not limited to Yttria Stabilized Zirconia, Aluminum Oxide (Alumina) or Yttrium Oxide (Yttiria). By providing an extruded filament 210, nano fine ceramic powder can be fed to a plasma jet to allow for even application without clumping of the powder particles. Similarly, nano fine powders can be used without generating the handling issues of conventional liquid suspension techniques. In addition, providing an extruded filament 210 with nano fine ceramic powder to plasma jet 225 produces a ceramic coating with a columnar structure. Columnar structures provide greater shear resistance. In addition, the waste stream is easier to handle than the waste stream from conventional spray techniques, such as liquid feed spray techniques.

According to one embodiment, plasma jet 225 burns off the organic material of the filament such that the plasticized particles can create coating 235 on substrate 240.

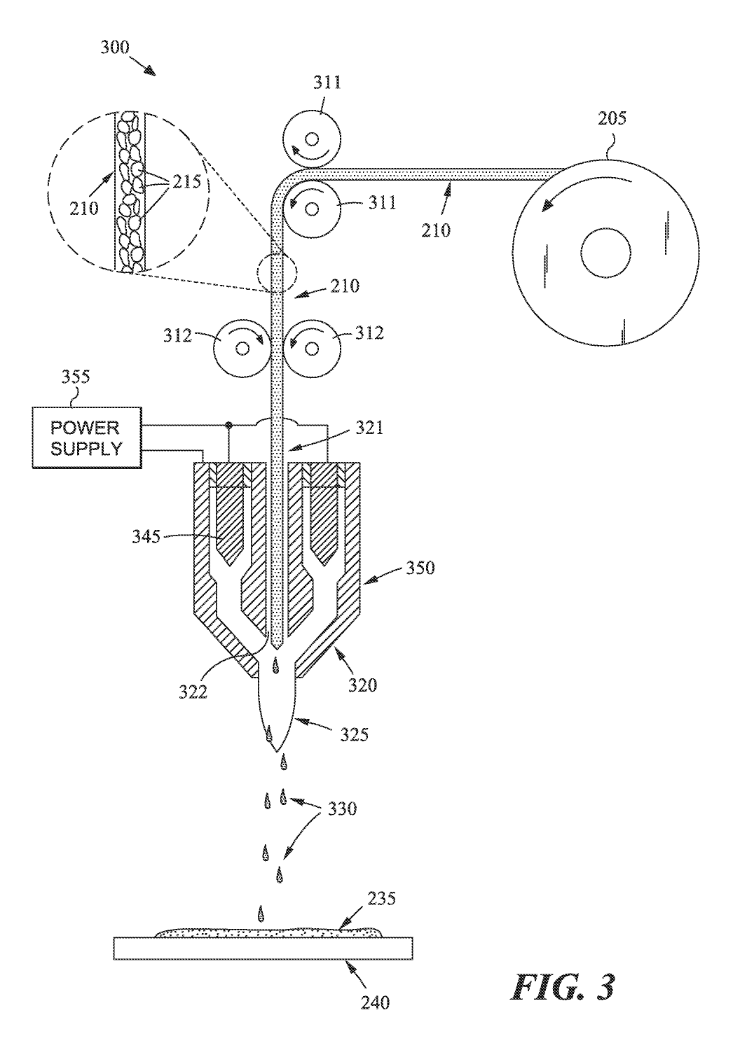

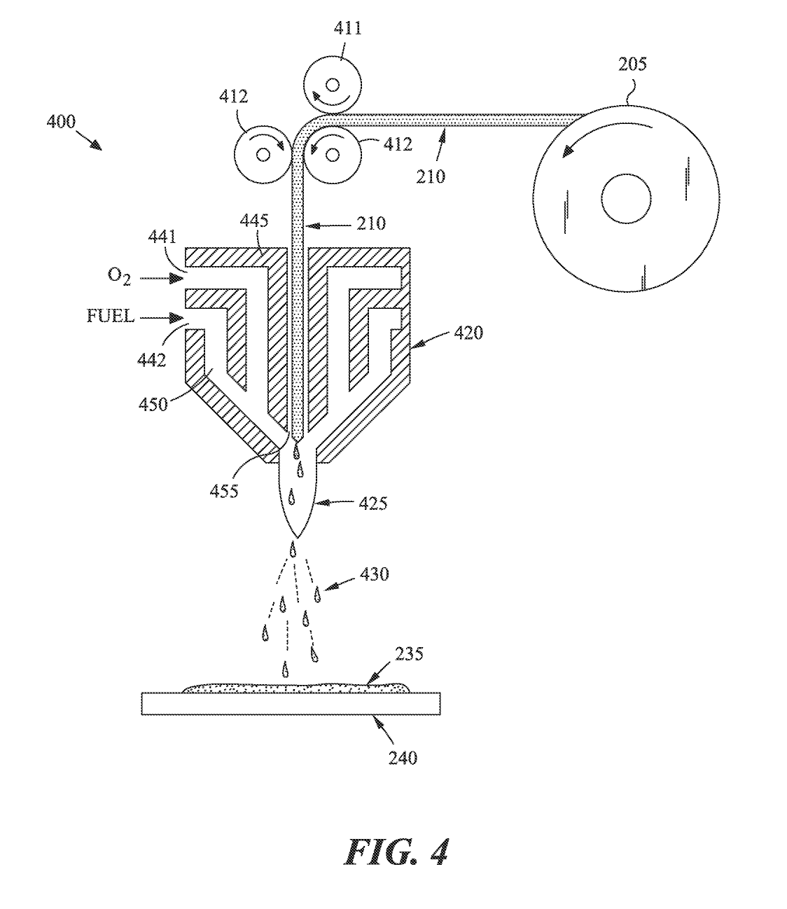

System 200 depicts a radial arrangement for feeding filament 210 to a plasma jet. It will be appreciated that the principles of operation of system 200 are similar to the arrangements described below with respect to FIGS. 3-4.

FIG. 3 depicts a graphical representation of an axial feed plasma spraying system 300 according to one or more embodiments. System 300 includes feed device 205, and plasma device 320, the feed device 205 configured to output filament 210 to plasma device 320.

System 300 is an axial feed configuration, and feeds filament 210 through an axial cavity, such as a channel 321, of plasma device 320. System 300 includes guide rollers 311 configured to receive the filament 210 from feed device 205. Feed rollers 312 feed filament 210 into plasma device 320. Plasma device 320 includes the channel 321 to receive and guide the filament 210. The diameter or width of the channel 321 is slightly larger than the filament 210 to be received. Filament 210 may be fed to plasma device 320 with inert gas such that the inert gas aids to advance the filament 210 through the receiving channel 321 and prevents melted filament from sticking within the channel 321 of the plasma device 320.

According to one embodiment, the plasma device 320 is an electric arc type plasma device for generating a plasma jet 325. Cathode(s) 345, anode(s) 350 and power supply 355 are configured to generate electric arcs to generate plasma jet 325 using inert gas, usually argon, which is blown through the arc to excite the gas.

Filament 210 is fed into plasma device 320 and is melted by plasma jet 325. The melted powder, shown as 322, is formed from ceramic particles 215 of filament 210 that are entrained in plasma jet 325 to form coating spray 330. Coating spray 330 forms a coating 235 on substrate 240. In one embodiment, organic binder material of the filament 210 is burned away by plasma source 325 such that spray 330 includes only, or substantially only, ceramic material (e.g., non-binder material) of the filament. System 300 may include a controller (e.g., controller 245) which may be employed to control operation of plasma device 320 and/or feed device 205.

FIG. 4 depicts a graphical representation of an axial feed plasma spraying system 400 according to one or more embodiments. System 400 includes a feed device 205, and a plasma device 420. The feed device 205 is configured to output a filament 210 to the plasma device 420.

System 400 is an axial feed configuration configured to feed the filament 210 through an axial cavity of plasma device 420. System 400 includes guide roller 411 configured to receive filament 210 from feed device 205. Feed rollers 412 feed filament 210 into plasma device 420. Plasma device 420 may include a channel to receive the filament, the channel having an opening or diameter slightly larger than the filament 210. Filament 210 may be fed to plasma device 420 with inert gas such that the inert gas aids to advance the filament 210 through the receiving channel and prevents sticking of the filament in the plasma device 420.

According to one embodiment, plasma device 420 is a High Velocity Oxy-Feed (HVOF) plasma device for generating a plasma jet 425. The plasma device 420 is configured to receive oxygen 441 and fuel (e.g., propane, propylene, or hydrogen, etc.) 442 via channels 445 and 450, respectively. Plasma device 420 is configured to supply oxygen to burn away binder material of filament 210. The configuration of plasma device 420 allows for filament 210 to be exposed to and inserted in the plasma jet 425. Oxygen 441 and fuel 442 are mixed and ignited in plasma device 420 to generate plasma jet 425. Fuel 442 is used for burning away the binder and plasticizing the powder particles of filament 210. Filament 210 is fed into plasma device 420 and melted by plasma jet 455 such that ceramic particles in filament 210 are entrained in plasma jet 425 to form coating spray 430. In one embodiment, organic binder material of the filament 210 is burned away by plasma source 425 such that spray 430 includes only, or substantially, ceramic material (e.g., non-binder material) of the filament.

Coating spray 430 forms a coating 235 on substrate 240. System 400 may include a controller (e.g., controller 245) which may be employed to control operation of plasma device 420 and/or feed device 205.

While this disclosure has been particularly shown and described with references to exemplary embodiments thereof, it will be understood by those skilled in the art that various changes in form and details may be made therein without departing from the scope of the claimed embodiments.

What is claimed is:

1. A method for plasma spraying, the method comprising:
controlling application of a filament embedded with powder particles to a plasma jet to generate a spray for coating a substrate.

2. The method for plasma spraying of claim 1, wherein the plasma jet is configured to burn away filament material such that the spray includes a plasticized ceramic coating.

3. The method for plasma spraying of claim 1, wherein the filament includes an organic material and the powder particles include ceramic powder particles, wherein the ceramic powder particles are embedded in the organic material.

4. The method for plasma spraying of claim 1, wherein the filament is an elongated material formed with a diameter in the range of 0.1 mm to 1 mm.

5. The method for plasma spraying of claim 1, wherein powder particles embedded within the filament have a diameter in the range of 1 nm to 0.001 cm.

6. The method for plasma spraying of claim 1, wherein the filament includes ceramic particles.

7. The method for plasma spraying of claim 1, wherein controlling application of filament includes applying the filament to the plasma jet at a controlled rate.

8. The method for plasma spraying of claim 1, wherein the filament is fed axially or radially into the plasma jet.

9. The method for plasma spraying of claim 1, further comprising controlling a plasma source to generate a plasma jet.

10. The method for plasma spraying of claim 9, wherein the embedded powder particles are plasticized by the plasma jet to form a coating for the substrate.

11. The method for plasma spraying of claim 1, further comprising controlling the position of at least one of a substrate and plasma device during coating or spraying.

12. A plasma spraying system comprising:
a plasma source;
a filament feed element configured to store and output a filament; and
a control coupled to the plasma source and filament feed element, wherein the control is configured to
control a plasma source to generate a plasma jet; and
control application of the filament to the plasma jet to generate a spray for coating a substrate.

13. The system of claim 12, wherein the plasma jet is configured to burn away filament material such that the spray includes a plasticized ceramic coating.

14. The system of claim 12, wherein the filament includes an organic material and the powder particles include ceramic powder particles, wherein the ceramic powder particles are embedded in the organic material.

15. The system of claim 12, wherein the filament is an elongated material formed with a diameter in the range of 0.1 mm to 1 mm.

16. The system of claim 12, wherein powder particles embedded within the filament have a diameter in the range of 1 nm to 0.001 cm.

17. The system of claim 12, wherein the filament includes ceramic particles.

18. The system of claim 12, wherein controlling application of filament includes application of the filament to the plasma jet at a controlled rate.

19. The system of claim 12, wherein the filament is fed axially or radially into the plasma jet.

20. The system of claim 12, wherein the filament is embedded with powder particles and wherein the spray is formed by powder that is plasticized and output by the plasma jet to the substrate.

21. The system of claim 12, the controller further configured to control a position of at least one of a substrate and plasma device during coating or spraying.

22. The system of claim 12, wherein the feed element includes one or more of a spool element and filament storage area.

23. The system of claim 12, wherein the system includes one or more rollers to apply the filament to the plasma jet.
